(19) United States
(12) Patent Application Publication
(10) Pub. No.: US 2008/0058008 A1
(43) Pub. Date: Mar. 6, 2008

(54) Mobile telecommunication apparatus with a built-in camera and the camera therein

(76) Inventor: Jae-Woong Yoon, Seoul (KR)

Correspondence Address: STAAS & HALSEY LLP, SUITE 700, 1201 NEW YORK AVENUE, N.W., WASHINGTON, DC, 20005, US

(21) Appl. No.: 11/882,580

(22) Filed: Aug. 2, 2007

Related U.S. Application Data
(60) Provisional application No. 60/834,819, filed on Aug. 2, 2006.

(51) Int. Cl. H04M 1/00; H04N 5/225

(52) U.S. Cl. 455/556.1; 348/373; 348/E05.024

(57) ABSTRACT

An apparatus for a mobile telecommunication is provided. A mobile telecommunication apparatus having a built-in camera including: a camera body to which a lens and an image signal detector are attached; a housing for accommodating the camera body; and a connection member disposed between the camera body and the housing, and forming a first turning axis and a second turning axis so that the camera body turns in relation to the housing with respect to two different turning axes independently from each other.

### CROSS-REFERENCE TO RELATED APPLICATIONS

This application claims the benefit of U.S. Provisional Application No. 60/834,819, filed Aug. 2, 2006, in the U.S. Patent and Trademark Office, the disclosure of which is incorporated herein by reference.

### BACKGROUND

1. Field

The present invention relates to a mobile telecommunication apparatus with a built-in camera and the camera therein, and more particularly, to a mobile telecommunication apparatus with a built-in camera having a digital camera function and a video telecommunication function, which is designed to change a shooting direction or adjust a shooting angle of the built-in camera with respect to different independent turning axes by using a direction change key or a direction key, and the camera therein. Accordingly, a user can easily and diversely change a shooting direction or adjust a shooting angle.

2. Description of the Related Art

With the development of mobile telecommunication technology, mobile telecommunication apparatuses with built-in cameras capable of receiving and transmitting voices and images have been introduced into the market. FIG. 10 is a view showing a conventional mobile telecommunication apparatus 30 with a built-in camera 300. As shown in FIG. 10, the conventional mobile telecommunication apparatus 30 has the camera 30 embedded in a binge shaft 33 on which a main body 31 and a folder 32 are turned. When a user adjusts a shooting angle of the camera 30 to obtain a desired image view, the shooting angle is typically adjusted in a limited range because of the one single hinge shaft. This becomes more problematic when the mobile telecommunication apparatus is used to photograph in a fixed state or when a shooting angle of the camera has to be controlled by other user in a video telecommunication

### SUMMARY

Additional aspects and/or advantages will be set forth in part in the description which follows and, in part, will be apparent from the description, or may be learned by practice of the invention.

Technical Problem

One embodiment or more embodiments of the present invention is to provide a mobile telecommunication apparatus with a built-in camera, which is capable of adjusting a shooting angle of the built-in camera with respect to different independent turning axes easily and diversely by using a direction key provided on the apparatus, and the camera therein.

Technical Solution

The above one embodiment or more embodiments are achieved by providing a mobile telecommunication apparatus with a built-in camera comprising a camera body 110 to which a lens 111 and an image signal detector 112 are attached, a housing 120 for accommodating the camera body, and a connection member disposed between the camera body and the housing, and forming a first turning axis (x) and a second turning axis (y) so that the camera body turns in relation to the housing with respect to two different independent turning axes (x, y).

Advantageous Effects

As described above, in the mobile telecommunication apparatus with the built-in camera according to an embodiment of the present invention, the camera body 110 and the connection member 130 simultaneously turn in relation to the housing 120 with respect to the first turning axis (x) substantially by 360° by a rotational force generated by a first driver. Independently from the first turning axis (x), the camera body 110 and the connection 130 also turn in relation to the housing 120 within a range of a predetermined angle smaller than 180° by a rotational force generated by a second driver 150. Accordingly, a user can change a shooting direction by using a direction change key 16 and also adjust a shooting angle easily and diversely by using a direction key 13.

### BRIEF DESCRIPTION OF THE DRAWINGS

These and/or other aspects and advantages will become apparent and more readily appreciated from the following description of the embodiments, taken in conjunction with the accompanying drawings of which:

FIGS. 1A-1C illustrate a view schematically showing a mobile telecommunication apparatus with a built-in camera according to an embodiment of the present invention;

FIGS. 2A and 2B illustrate a turning operation of a camera body according to an embodiment of the present invention;

FIG. 3 illustrates a cross section view of the camera according to an embodiment of the present invention;

FIG. 4 is an exploded view of the camera according to an embodiment of the present invention;

FIG. 5 is a view showing a driver according to an embodiment of the present invention;

FIGS. 6A and 6B illustrate an operation of a detector according to an embodiment of the present invention;

FIG. 7 is a block diagram of the mobile telecommunication apparatus according to an embodiment of the present invention;

FIG. 8 is a block diagram of a camera driver according to an embodiment of the present invention;

FIG. 9 is a flowchart showing a process of changing a shooting direction and adjusting a shooting angle of the camera of the mobile telecommunication apparatus according to an embodiment of the present invention; and

FIG. 10 is a view schematically showing a conventional mobile telecommunication apparatus with a built-in camera.

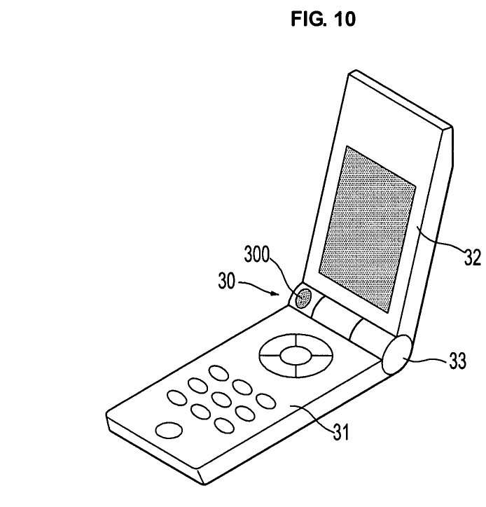

### DESCRIPTION OF THE REFERENCE NUMERALS IN THE DRAWINGS

10 mobile telecommunication apparatus
100 camera
110 camera body
120 housing
130 connection member
140 first driver
150 second driver
160 first detector
170 second detector
180 protection cover

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

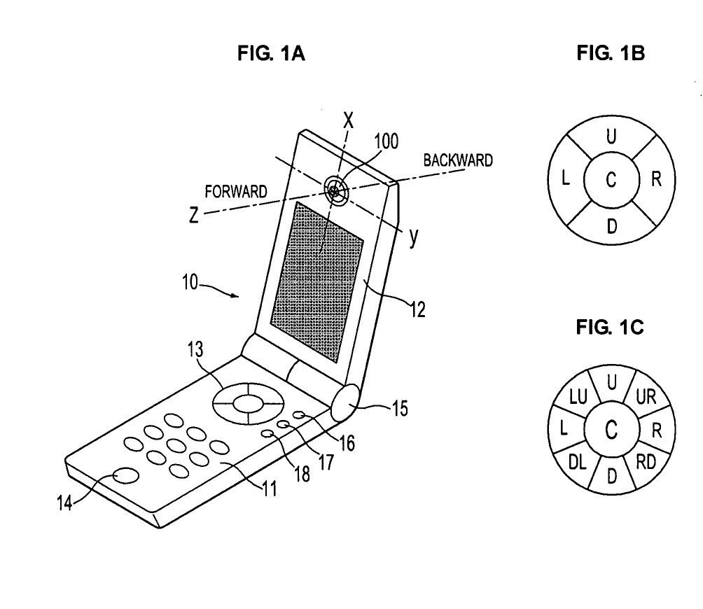

FIGS. 1A-1C illustrate a view schematically showing a mobile telecommunication apparatus 10 having a built-in camera 100 according to an embodiment of the present invention.

As shown in FIG. 1A, the camera 100 is located in an upper end of a folder part 12. A main body 11 is provided with a direction key 13 for adjusting a shooting angle of the camera 100, a direction change key 16 for changing a shooting direction according to whether the shooting direction of the camera is a forward direction or a backward direction, a camera mode key 17 for starting a camera mode, and a camera mode end key 18 for ending the camera mode.

The main body 11 has a receiving recess 14 formed in a lower end thereof for receiving a part of the camera so that the folder part can be completely folded into the main body with respect to a hinge shaft 15. This is because the camera 100 is thicker than the folder part 12. As shown in FIG. 1B, the direction key 13 consists of keys U, R, D, L, C. Alternatively, another type of the direction key in which keys UR, RD, DL, LU are located among keys U, R, D, L.

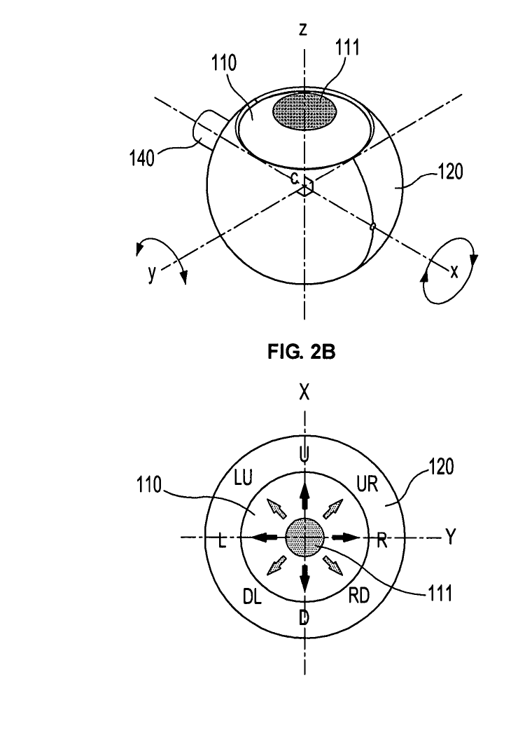

Hereinafter, operations for changing a shooting direction of the camera 100 and adjusting a shooting angle according to an embodiment of the present invention will now be described with reference to FIGS. 2A and 2B. FIGS. 2A and 2B are illustrate a turning operation of a camera body 110 according to an embodiment of the present invention.

FIG. 2A is a view of the camera 100 as seen from the side, and FIG. 2B is a view of the camera as seen from the front of the lens 111. As shown in FIGS. 2A and 2B, the camera body 110 having the lens 111 attached thereto turns in relation to a housing 120 for accommodating the camera body with respect to two turning axes (x, y). One of the two turning axes is a first turning axis (x), and the other is a second turning axis (y).

The camera body 110 is designed to turn about the first turning axis (x) by substantially 360° and turn about the second turning axis (y) within a predetermined angle less than 180°. Accordingly, the camera body 110 is able to change a shooting direction according to whether the shooting direction is a forward direction or a backward direction and also adjust a shooting angle after the change of shooting direction. When the shooting angle needs to be adjusted, it is achieved by turning the camera body 110 with respect to the second turning axis (y).

First, a user determines a shooting direction, and if necessary, changes the shooting direction of the camera 100 by using the direction change key 16. Once the shooting direction is determined, the user adjusts the turning of the camera body 110 by manipulating the five keys (U,D,C,R,L) of the direction key 13 to obtain an appropriate image view from a shooting object. For example, if the user presses the key U, the camera body 110 tams in a direction U. If the user presses the key D, the camera body 110 turns in a direction D. If the user presses the key R, the camera body 110 turns in a direction R. If the user presses the key L, the camera body 110 turns in a direction L. The key C initializes so that a center of the lens 111 attached to the camera body 110 is substantially identical to an intersection (c) of the first turning axis (x) and the second turning axis (y) as seen from the front of lens. In this case, the turning movement of direction U or D of the camera body 110 is performed independently from the turning movement of direction R or L. This means that the camera body 110 can turn in the direction R or L regardless of the turning movement of direction U or D. For example, when the user presses the key R in the middle of the turning of the direction U, the camera body turns in the direction R regardless of the turning movement of the direction U. As mentioned above.

FIG. 1C illustrates a substitute direction key for the direction key 13 of FIG. 1B. For example, if the user presses the key UR, the camera body 110 turns in a direction UR as shown in FIG. 2B, which has the same result as in case that the keys U and R are pressed simultaneously. The keys RD, DL and LU are convenient for the camera body 110 to turn in directions RD, DL, and LU rapidly as shown in FIG. 2B.

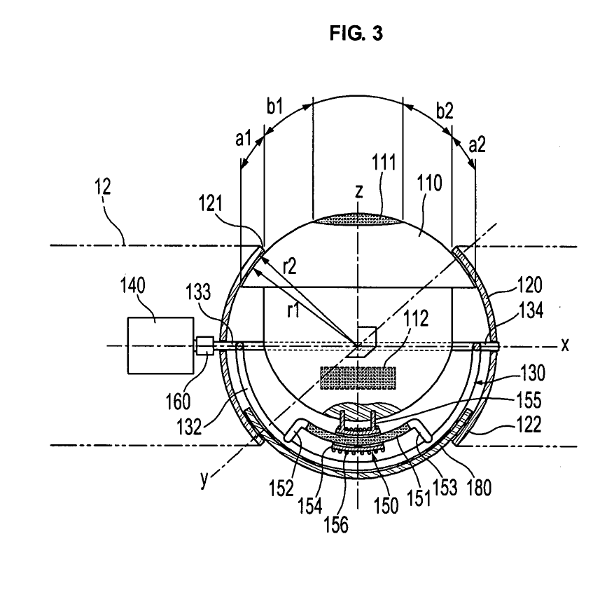

FIG. 3 illustrates a cross section view of an interior of the camera 100 according to an embodiment of the present invention, taken along the axis x of FIG. 1.

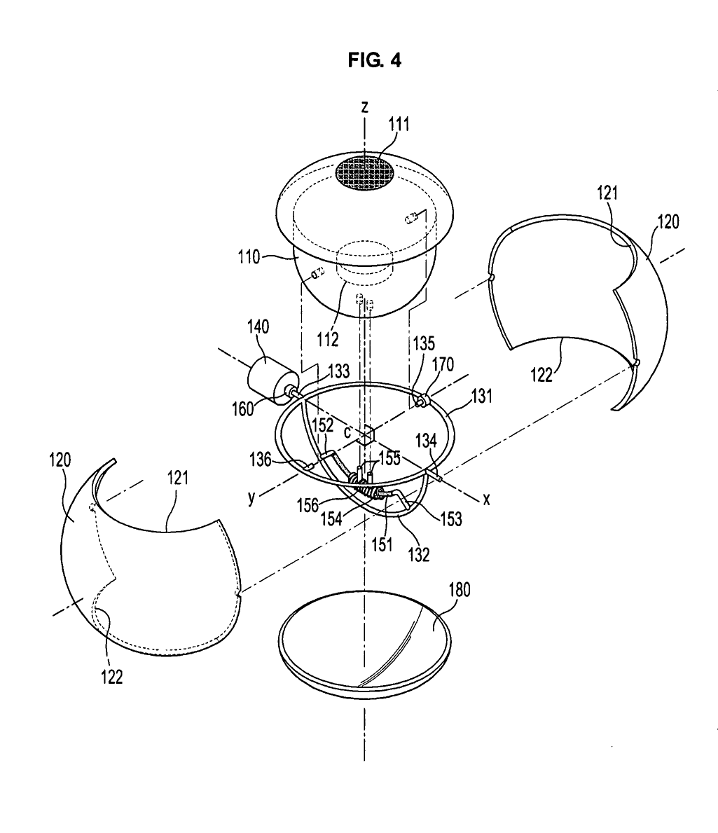

FIG. 4 is an exploded view showing the camera 100 according to an embodiment of the present invention. The construction of the camera 100, which is enabled to turn the camera body 110 as explained in FIG. 2, will now be described with reference to FIGS. 3 and 4. Referring to FIGS. 3 and 4, the interior of the camera 100 according to an embodiment of the present invention consists of the camera body 110, the housing 120, a connection member 130, a second driver 150, a second detector 170, and a protection cover 180.

In addition, a first driver 150 and a first detector 160 disposed on an exterior of the housing 120 of the camera 110 are main parts for the embodiment of the present invention. The camera body 110 receives an image from a shooting object through the lens 111 and converts the received image into a video signal through an image signal detector 112. Although a number of elements are attached to the camera body 110, since they have no direct relation with the present invention, only the lens 111 and the image signal detector 2 are illustrated. The housing 120 accommodates the camera body 110 and serves as a reference on which the camera body 110 turns. For this, the housing 120 is not necessarily detachable from the mobile telecommunication apparatus 10. Any housing part formed on the mobile communication apparatus 10 could be the housing of the present invention if it accommodates the camera body 110 and serves as a reference for the turning of the camera body.

As shown in FIGS. 3 and 4, the housing 120, the shape of which resembles a sphere, has a first opening 121 and a second opening 122 respectively formed in opposite end thereof so that the lens 111 is exposed to the outside through the first or the second opening 121 or 122 according to the shooting direction. Lens circumferential sections a1, b1, b2, a2 of the camera body 110 has a sphere shape. The sections b1 and b2 are exposed from the housing 120, while the sections a1 and a2 are spaced from the housing 120 by a predetermined distance and concealed by the housing. A radius r1 of the sphere formed by the lens circumferential areas a1, b1, b2, a2 is smaller than a radius r2 of the sphere of the housing 120 so that the camera body can turn within the housing with a predetermined gap therebetween.

The lens circumferential sections a1, b1, b2, a2 has such a size that the interior of the housing 120 is not exposed even when the camera body 110 turns to the maximum degree in any direction with respect to the first turning axis (x) and the second turning axis (y) for the adjustment of the shooting angle. Therefore, foreign substance is prevented from entering the housing during the adjustment of the shooting angle.

The protection cover 180 has also a sphere shape and has the same size as that of the sphere formed by the lens circumferential sections. The protection cover 180 is attached to a lower end of the connection member 130 located at an opposite side to the lens. Due to the presence of the protection cover 180, the interior of the housing is prevented from being exposed to the outside through the second opening when the lens 111 of the camera body 110 is exposed to the outside through the first opening 121 after turning. The protection cover also prevents the housing from being exposed to the outside through the first opening when the lens of the camera body is exposed through the second opening 122 after turning.

The connection member 130 comprises a circular first supporter 131, a half-circular second supporter 132 connected to the first supporter, and first turning protrusions 133, 134 and second turning protrusions 135, 136 formed on the first supporter. The first turning protrusions 133, 134 form the first turning axis (x). One 133 of the first turning protrusions is connected to a turning shaft of the first driver 140, thereby receiving a rotational force. The other 134 is rotatably connected to the housing 120. The first driver 140 according to an embodiment of the present invention is a small-sized motor. The second turning protrusions 135, 136 form the second turning axis (y) and are connected to the camera body 110. The first turning axis (x) formed by the first turning protrusions and the second turning axis (y) formed by the second turning protrusion are substantially perpendicular to each other as seen from the front of the lens 111. By the rotational force of the first driver, the camera body 110 and the connection member 130 turns in relation to the housing 120 substantially by 360° with respect to the first turning axis (x). The second supporter 132 of the connection member 130 is provided with a magnet 151 and a magnet supporter 152, 153, which belong to the second driver 150, to generate a rotational force to turn the camera body 110 with respect to the second turning axis (y).

By the rotational force of the second driver 150, the camera body 110 turns in relation to the housing with respect to the second turning axis (y) within a predetermined angle smaller than 180° individually from the turning with respect to the first turning axle (x).

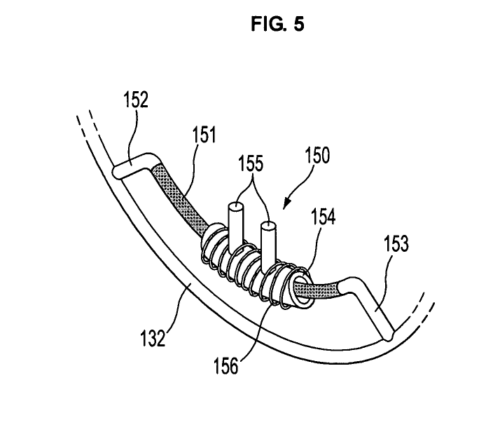

With reference to FIG. 5, the construction of the second driver 150 is described. FIG. 5 is a view showing the second driver 150 according to an embodiment of the present invention.

As shown in FIG. 5, the magnet 151 has a predetermined curvature and has opposite ends thereof fixed to an upper end of the second supporter 132 through the magnet supporters 152, 153. A tube 154 wounded by a coil 156 is fixed to a lower end of the camera body 110 by a tube supporter 155. The tube 154 has an inner diameter sufficient to move along a lengthwise direction of the magnet without contacting the magnet 151.

The tube fixed to a lower end of the camera body 110 through the tube supporter turns with respect to the second turning axis _{(y)} along the lengthwise direction of the magnet by electric current flowing thorough the coil. According to the principle of electromagnet, the strength of the driving force generated by the second driver 150 depends on the number of turns of the coil 156 or the magnitude of the electric current flowing through the coil. The tube moves with a limitation that is determined by the magnet supporter 152, 153.

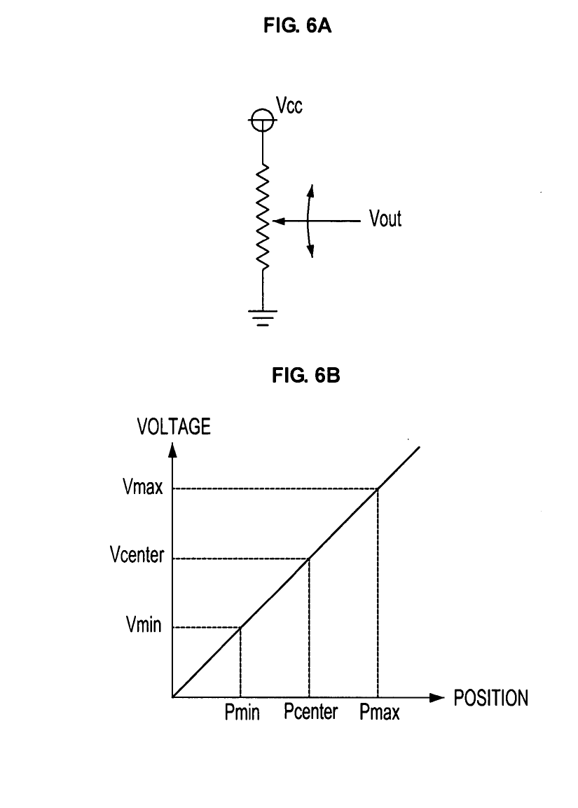

Accordingly, the magnet supporter supports the magnet and also functions as a stopper to stop the movement of the tube. FIGS. 6A and 6B illustrate a view showing the operation of the detectors 160, 170 according to an embodiment of the present invention.

As shown in FIG. 6A, the detectors 160, 170 consist of a variable resistance so that an output voltage Vout of the variable resistance is changed according to the position of the camera body 110 after turning. FIG. 6B shows a relationship between the output voltage Vout of the variable resistance and the location of the camera body 110 after turning. For example, if the camera body 110 turns with respect to the first turning axis (x), a position Pmax after the camera body 110 turns to the maximum degree in one direction corresponds to an output voltage Vmax of the variable resistance. A position Pmin after the camera body turns to the maximum degree in opposite direction corresponds to an output voltage Vmin of the variable resistance. If the camera body is positioned between the Pmax and the Pmin, the position of the camera body is expressed by Pcenter and its corresponding output voltage of the variable resistance is Vcenter. As a result, the current position of the camera body 110 is in proportion to the output voltage Vout of the variable resistance 160, 170.

Accordingly, the position of the camera body 110 after turning is determined based on the output voltage Vout of the variable resistance. Although the detectors 160, 170 determine the position of the camera body 110 after turning by using the variable resistance, it is apparent to those skilled in the art that another element can be used to determine the position of the camera body 110, and thus its additional description is omitted.

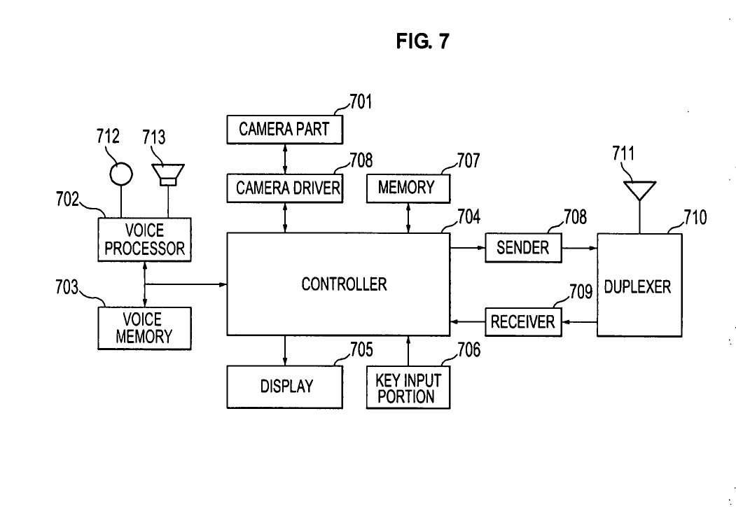

FIG. 7 illustrates a block diagram showing the mobile telecommunication apparatus 10 according to an embodiment of the present invention. As shown in FIG. 7, a controller 704 controls the overall operations of the mobile telecommunication apparatus 10. A memory 707 stores a control program of the mobile telecommunication apparatus 10 and a control data created under the control of the controller 704. A key input portion 706, albeit not shown, comprises a plurality of dialing keys, a menu key, the dⁱrection key 13, the direction change key 16, the camera mode key 17, the camera mode end key 18, a side key, a send key and an end key.

A voice memory 703 stores a plurality of voice messages, and a voice processor 702 processes a voice message read out from the voice memory 703 under the control of the controller 704 in an analog form and send out it through a speaker 713. The voice processor 702 digitalizes an analog voice inputted from a user through a microphone 712. A sender 708 performs a digital-wireless-modulation with respect to a signal received from the controller and transmits the signal to a duplexer 710.

The duplexer 710 sends out the wireless signal received from the sender 708 through an antenna 711, and transmits a wireless signal received through the antenna to a receiver 709. The receiver 709 performs a demodulation with respect to the wireless signal received from the duplexer 710 and transmits it to the controller 704. The controller 704 controls a telecommunication in correspondence to the received signal. A display 705 is embodied by a LCD (Liquid Crystal Display Unit) or a LED (Light Emitting Diode), and it displays a control signal and an input signal of the mobile telecommunication apparatus 10 controlled by the controller 704.

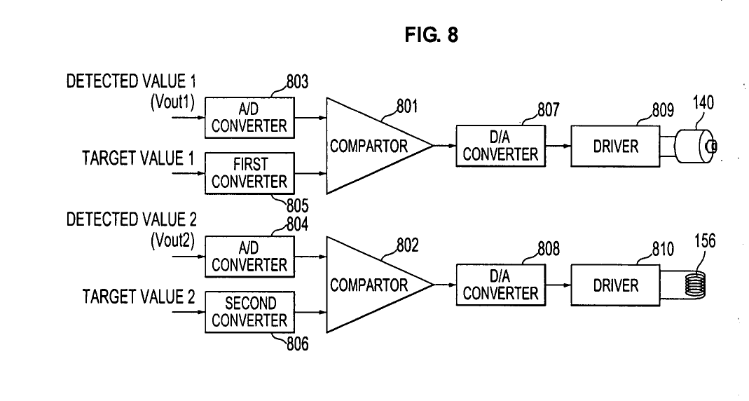

FIG. 8 illustrates a block diagram showing the operation of the camera driver of FIG. 7. With reference to FIG. 8, the operation of the camera driver according to an embodiment of the present invention will now be described herein below. An A/D converter 803 receives a detected value 1 of the output value Vout from the first detector 160 and converts it into a digital signal, and a first counter 805 is inputted with a target value 1, which has been set by the user's manipulation of the direction key 13 or the direction change key 16, from the controller 704. A comparator 801 receives resultants outputted from the A/D converter 803 and the first counter 805 and compares the two signals. A result of the comparison is transmitted to a D/A converter 807, and a difference signal is converted into an analog signal, amplified by a driver 809 and then transmitted to the first driver 140. Also, the A/D converter 804 receives a detected value 2 of the output voltage Vout from the second detector 170 and converts it into a digital signal, and the second counter 806 is inputted with a target value 2, which has been set by the user's manipulation of the direction key 13, from the controller 704.

The comparator 802 receives resultants output from the A/D converter 804 and the second counter 806, and compares the two signals. A result of the comparison is transmitted to the D/A converter 808, and a difference signal is converted into an analog signal, amplified by the driver 810 and is transmitted to the coil 156 of the second driver. As a result, a user can adjust the shooting angle of the camera with respect to the two independent turning axes (x,y) diversely and easily by using the direction key 13, and also changes the shooting direction of the camera by simply manipulating the direction change key 16.

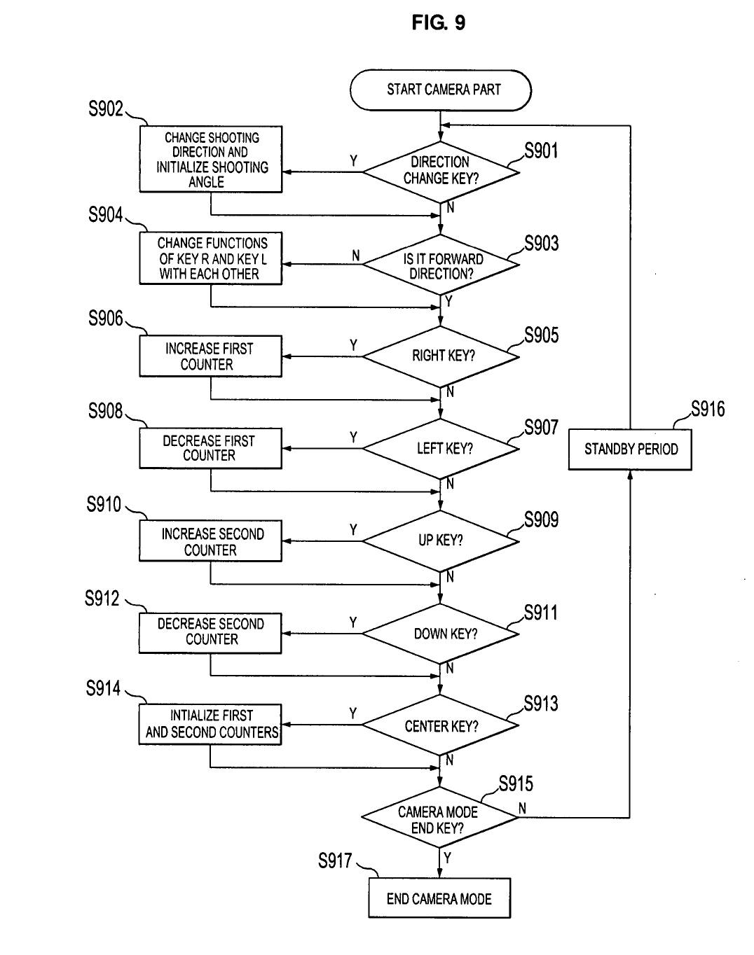

FIG. 9 illustrates a process of changing a shooting direction and adjusting a shooting angle of the camera 10 of the mobile telecommunication apparatus according to an embodiment of the present invention.

As shown in FIG. 9, in operation S901, the controller 704 determines whether there is an input from the direction change key 16. If there is an input from the direction change key, the process performs operation S902, and if not, the process jumps to operation S903. In the operation S902, a shooting direction is changed and a shooting angle is initialized. In the operation S903, the controller 704 determines whether the current shooting direction is a forward direction. If the current shooting direction is a forward direction, the process jumps operation S905, and if not, the process performs operation S904. In the operation S904, the key R and the key L change their respective inherited functions with each other, and then the process performs the operation S905. In the operation S905, the controller 704 determines whether there is an input from the key R. If there is an input from the key R, the process performs operation S906 to increase the first counter 805 by 1, and if not, the process jumps to operation S907. In the step S907, the controller 704 determines whether there is an input from the key L. If there is an input from the key L, the process performs step S908 to decrease the first counter 805 by 1 and then performs step S909. If not, the process jumps to the step S909.

In the operation S909, the controller 704 determines whether there is an input from the key U. If there is an input from the key U, the process performs operation S910 to increase the second counter 806 by 1 and then performs operation S911, and if not, the process jumps to operation 5911. In the operation S911, the controller 704 determines whether there is an input from the key D. If there is an input from the key D, the process performs operation S912 to decrease the second counter 806 by 1 and then performs operation S913, and if not, the process jumps to operation S913. In the operation S913, the controller 704 determines whether there is an input from the key C. If there is an input from the key C, the process performs operation S914 to initialize the first counter 805 and the second counter 806 and then performs operation S915, and if not, the process jumps to operation S915. In the operation S915, the controller 704 determines whether there is an input from the camera mode end key.

If there is an input from the camera mode end key, the process performs the operation S917 to end the camera mode, and if not, the process jumps to operation S916. In the operation S916, the process has a predetermined standby period until the next adjustment of the shooting angle is made. Although the flowchart as described above relates to a case where the shooting angle is adjusted by using the direction key 13 of FIG. 1B, it is apparent to those skilled in the art that the above flowchart is applicable to a case where the direction key of FIG. 1C is used. The foregoing embodiments are merely exemplary and are not to be construed as limiting the present invention. Many alternatives, modifications, and variations will be apparent to those skilled in the art within the scope of the present invention. For example, a small-sized motor, which is disposed at one side of the second turning protrusions 135, 136, is substituted for the second driver 150. The modifications of camera structure resulted from this is apparent to those skilled in the art.

One or more embodiment of the present invention provides the mobile telecommunication apparatus with the built-in camera having a digital camera function and a video telecommunication function. The camera is designed to turn with respect to the two different independent axes so that a user can change a shooting direction of the camera and adjust a shooting angle easily and diversely by using the direction change key and the direction key provided on the apparatus.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A mobile telecommunication apparatus having a built-in camera comprising: a camera body to which a lens and an image signal detector are attached; a housing for accommodating the camera body; and
a connection member disposed between the camera body and the housing, and forming a first turning axis and a second turning axis so that the camera body turns in relation to the housing with respect to two different turning axes independently from each other.

2. The mobile telecommunication apparatus as claimed in claim 1, comprising: a first driver for generating a driving force to turn the camera body with respect to the first turning axis; and
a second driver for generating a driving force to turn the camera body with respect to the second turning axis.

3. The mobile telecommunication apparatus as claimed in claim 2, comprising a detector for detecting a position of the camera body after turning.

4. The mobile telecommunication apparatus as claimed in claim 3, comprising a direction key to turn the camera body with respect to the first turning axis and the second turning axis, independently.

5. The mobile telecommunication apparatus as claimed in claim 4, wherein the first turning axis and the second axis are substantially perpendicular to each other as seen from the front of the lens.

6. The mobile telecommunication apparatus as claimed in claim 5, wherein the camera body is designed to change a shooting direction with respect to the first turning axis according to whether the shooting direction is a forward direction or a backward direction.

7. A camera comprising:
a camera body to which a lens and an image signal detector are attached; a housing for accommodating the camera body; and
a connection member disposed between the camera body and the housing, and forming a first turning axis and a second turning axis so that the camera body turns in relation to the housing with respect to two different turning axes independently from each other.

8. The camera as claimed in claim 7, wherein the first turning axis and the second axis are substantially perpendicular to each other as seen from the front of the lens.

9. The camera as claimed in claim 8, wherein the camera body is designed to change a shooting direction with respect to the first turning axis according to whether the shooting direction is a forward direction or a backward direction.
